(19) United States
(12) Patent Application Publication
(10) Pub. No.: US 2026/0290828 A1
(43) Pub. Date: Sep. 24, 2026

(54) ZINC SULFUR ELECTROCHEMICAL STORAGE SYSTEM AND METHOD OF USING DICHALCOGENIDE CATALYST

(71) Applicant: The Research Foundation for The State University of New York, Albany, NY (US)

(72) Inventors: Amy C. Marschilok, Stony Brook, NY (US); Kenneth J. Takeuchi, Stony Brook, NY (US); Esther S. Takeuchi, Stony Brook, NY (US)

(21) Appl. No.: 19/570,070

(22) Filed: Mar. 17, 2026

Related U.S. Application Data
(60) Provisional application No. 63/773,802, filed on Mar. 18, 2025.
(60) Provisional application No. 63/915,337, filed on Nov. 11, 2025.

(51) Int. Cl. H01M 4/62; H01M 4/38; H01M 10/24

(52) U.S. Cl. CPC H01M 4/62; H01M 4/38; H01M 4/625; H01M 10/24

(57) ABSTRACT

An aqueous zinc sulfur electrochemical energy storage system including a zinc anode and a sulfur-based cathode in which the overpotential of the conversion reaction of S to ZnS in an aqueous electrolyte is reduced by incorporating a catalyst, such as, for example, a dichalcogenide catalyst or a dichalcogenide-like catalyst, in the sulfur-based cathode. The electrochemical energy storage system including the overpotential reducing catalyst provides a pathway for high-performance and sustainable energy storage.

### CROSS-REFERENCE TO RELATED APPLICATION

This disclosure claims benefit of priority to U.S. Provisional Patent Application Ser. No. 63/915,337, filed Nov. 11, 2025, and U.S. Provisional Patent Application Ser. No. 63/773,802, filed Mar. 18, 2025, the contents of which are both incorporated herein by reference in their entirety.

### FIELD OF THE INVENTION

The present disclosure relates to an electrochemical energy storage system, and more particularly to an aqueous zinc sulfur (Zn/S) electrochemical energy storage system including a zinc anode and a sulfur-based cathode that includes a catalyst that reduces the overpotential of the conversion reaction of sulfur(S) to zinc sulfide (ZnS) in an aqueous electrolyte.

### BACKGROUND

Increasing global energy demand necessitates the exploration of environmentally friendly, cost-effective, safe, and sustainable energy storage alternatives beyond lithium-ion batteries. Aqueous Zn/S batteries have emerged as promising candidates due to the abundance and low cost of zinc and sulfur, which are the 24th and 10th most abundant elements in the earth's crust, respectively. Sulfur, in particular, offers a high theoretical capacity (of approximately 1670 mA h g⁻¹) as a conversion-based cathode. When coupled with a zinc anode in an aqueous electrolyte, this combination presents an opportunity for sustainable battery technology with a low chemical cost. The redox mechanism in these batteries typically involves the conversion of S to ZnS. Despite their promise, aqueous Zn/S batteries suffer from significant challenges, primarily the sluggish kinetics of the S to ZnS conversion reaction, which leads to large polarization due to the low conductivity of elemental sulfur and its discharge product, ZnS.

To overcome these kinetic limitations, the use of catalysts has been explored in various battery systems. Molybdenum (Mo) is an abundant transition metal, and its sulfide, molybdenum (IV) sulfide (MoS₂), is an inexpensive material known for its catalytic properties in sulfur reduction and oxidation in lithium-sulfur batteries and other applications. While MoS₂ has shown efficacy in non-aqueous systems, its potential as a catalyst in aqueous Zn/S batteries had been largely unexplored.

### SUMMARY

The present disclosure provides an aqueous Zn/S electrochemical energy storage system designed for efficient electrochemical storage. The electrochemical energy storage system of the present disclosure includes a zinc anode and a sulfur-based cathode in which the overpotential of the conversion reaction of S to ZnS in an aqueous electrolyte is reduced by incorporating a catalyst, such as, for example, a dichalcogenide catalyst or a dichalcogenide-like catalyst, in the sulfur-based cathode. The reduction of the overpotential provided by the inclusion of the catalyst in the cathode improves the performance of the electrochemical energy storage system, which in some embodiments, is a battery.

Notably, the present disclose provides a system for electrochemical energy storage. In one embodiment of the present disclosure, the system comprises an anode comprising zinc; a cathode comprising sulfur and a catalyst for enhancing electrochemical conversion of sulfur to zinc sulfide; an aqueous electrolyte comprising zinc ions facilitating ionic transport between the anode and the cathode; and a separator positioned between the anode and the cathode. The inclusion of the catalyst in the cathode reduces the overpotential associated with the sluggish sulfur to zinc sulfide electrochemical reaction thereby improving the performance of the electrochemical energy storage of the present disclosure. The electrochemical energy storage system including the catalyst provides a pathway for high-performance and sustainable energy storage.

In some embodiments of the present disclosure, the catalyst facilitates electrochemical formation of a zinc disulfide (ZnS₂) intermediate phase during a discharge process. Understanding of the reaction pathway provides insight into facilitating the reversibility (rechargeability) of the system.

In some embodiments of the present disclosure, the catalyst comprises a dichalcogenide catalyst, a dichalcogenide-like catalyst or a combination thereof. These catalyst are heterogeneous catalysts that have the ability to enhance, through overpotential reduction, the conversion reaction of S to ZnS.

In some embodiments of the present disclosure, the catalyst comprises a transition metal dichalcogenide comprising a transition metal and sulfur.

In some embodiments of the present disclosure, the transition metal dichalcogenide is stoichiometric.

In some embodiments of the present disclosure, the transition metal dichalcogenide is non-stoichiometric.

In some embodiments of the present disclosure, the transistor metal of the transition metal dichalcogenide comprises iron, nickel, cobalt, titanium or molybdenum.

In some embodiments of the present disclosure, the catalyst comprises molybdenum (IV) sulfide (MoS₂).

In some embodiments of the present disclosure, the catalyst comprises a nanosheet catalyst, a bulk catalyst or a combination thereof.

In some embodiments of the present disclosure, the cathode further comprises at least one electrical conductivity enhancer. The presence of the least one electrical conductivity enhancer in the cathode enhances the cathode's electrical conductivity, contributing to better charge transfer in the electrode.

In some embodiments of the present disclosure, the at least one electrical conductivity enhancer comprises a carbonaceous material, an electrically conductive metal, an electrically conductive metal alloy or any combination thereof.

In some embodiments of the present disclosure, the at least one electrical conductivity enhancer comprises at least a carbonaceous material, and the carbonaceous material comprises one of a carbon nanotube, graphene, graphite or carbon black.

In some embodiments of the present disclosure, the sulfur, the catalyst and the at least one electrical conductivity enhancer are present in the cathode in a mass ratio of from about 90:5:5 to about 1:1:1.

In some embodiments of the present disclosure, the catalyst is molybdenum (IV) sulfide (MoS₂), and the at least one the at least one electrical conductivity enhancer is a carbon nanotube, and the sulfur, the molybdenum (IV) sulfide (MoS₂), and the carbon nanotube are present in the cathode in a mass ratio selected from 5:4:4, 2:5:5, 2:1:2 or 5:1:4.

In some embodiments of the present disclosure, the cathode is free of a binder.

In some embodiments of the present disclosure, the cathode further comprises a binder.

In some embodiments of the present disclosure, the anode, the cathode, the aqueous electrolyte and the separator are components of a battery. Batteries including the cathode of the present disclosure exhibit improved performance including, for example, enhanced conversion of sulfur to zinc sulfur. Batteries of the present disclosure are rechargeable and represent an environmentally friendly, cost-effective, safe, and sustainable energy storage alternatives beyond lithium-ion batteries.

In another embodiment of the present disclosure, the system comprises an anode comprising zinc; a cathode comprising sulfur, a dichalcogenide catalyst effective in enhancing electrochemical conversion of sulfur to zinc sulfide, and at least one electrical conductivity enhancer; an aqueous electrolyte comprising zinc ions facilitating ionic transport between the anode and the cathode; and a separator positioned between the anode and the cathode. The inclusion of the catalyst in the cathode reduces the overpotential associated with the sluggish sulfur to zinc sulfide electrochemical reaction thereby improving the performance of the electrochemical energy storage, and the presence of the least one electrical conductivity enhancer in the cathode enhances the cathode's electrical conductivity, contributing to better charge transfer in the electrode. The electrochemical energy storage system including the catalyst provides a pathway for high-performance and sustainable energy storage.

In some embodiments of the present disclosure, the dichalcogenide catalyst is molybdenum (IV) sulfide (MoS₂).

In some embodiments of the present disclosure, the least one electrical conductivity enhancer is a carbon nanotube.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the present disclosure shown where illustration is not necessary to allow those of ordinary skill in the art to understand the present disclosure.

FIG. 1 is a schematic of an aqueous Zn/S electrochemical energy storage system in accordance with an embodiment of the present disclosure.

FIG. 2A is a graph illustrating galvanostatic profiles for various cathodes at different ratios of S:MoS₂:CNT in accordance with the present disclosure, and a cathode including S/CNT, but no MoS₂ catalyst.

FIG. 2B is a graph showing the corresponding dQ/dV data from Zn/S cells discharged at 100 mA g⁻¹ to 0.25 V, utilizing different ratios of S:MoS₂:CNT and S:CNT components.

FIG. 2C shows Mo K-edge X-ray absorption analysis of a pristine cathode/electrode and discharged states and S:MoS₂:CNT cathode in accordance with the present disclosure.

FIG. 2D shows extended X-ray absorption fine structure (EXAFS) spectra for the pristine and discharged states compared to the cathode containing MoS₂.

FIG. 2E is a graph showing EXAFS fitting results for a pristine electrode.

FIG. 2F is a graph showing EXAFS fitting results and after discharge of a cathode in accordance with the present disclosure.

FIG. 2G is a Raman spectrum of the pristine state, due to the high intensity of the sulfur peaks, the inset provides a magnified view of the peaks associated with MoS₂.

FIG. 2H is Raman spectrum representing the averaged results after discharge.

FIG. 2I is a Raman spectrum of the averaged ZnS spectra after discharge. Due to the high intensity of the sulfur peaks, the inset provides a magnified view of the peaks associated with ZnS.

FIG. 3A-3C are TEM images of aggregated solids from the discharged electrode.

FIGS. 3D, 3H, and 3L are HAADF images of aggregated solids from the discharged electrode.

FIGS. 3E, 3I, and 3M are EDX maps of aggregated solids from the discharged electrode.

FIGS. 3F and 3G are the HRTEM and the corresponding SAED pattern in the region f labeled in FIG. 2A.

FIGS. 3J and 3K are the HRTEM and the corresponding SAED pattern in the region j labeled in FIG. 2A.

FIGS. 4A and 4B are SEM images collected on the discharged electrode.

FIG. 4C is an in-situ synchrotron-based X-ray computed tomography (XCT) image of pristine S:MoS₂:CNT cathode.

FIG. 4D is an in-situ synchrotron-based X-ray computed tomography (XCT) image of a discharged S:MoS₂:CNT cathode.

FIG. 4E is a schematic of MoS₂ particle covered in smaller ZnS particles post discharge.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

Embodiments of the present disclosure described herein provide an aqueous Zn/S electrochemical energy storage system (e.g., a Zn/S rechargeable battery) in which a catalyst is incorporated/included in the sulfur-based cathode to improve the performance of the electrochemical energy storage system by reducing the overpotential associated with the electrochemical reaction of sulfur to zinc sulfide. Such a catalyst can be referred to as “an overpotential reducing catalyst”. The overpotential reducing catalyst is a heterogeneous catalyst in which the conversion reaction of sulfur to zinc sulfur occurs on. The system of the present disclosure provides a non-flammable water-based electrochemical energy storage system, e.g., battery, using earth abundant materials. By incorporating the overpotential reducing catalyst into the S-based cathode to improve the system's kinetics, an electrochemical energy storage system (e.g., battery) can be developed for use that is safer and cheaper than today's existing technologies.

Aqueous Zn/S electrochemical energy storage systems are conceptually appealing because they are low cost, earth abundant and safe materials within an energy storage system. aqueous Zn/S electrochemical energy storage systems operate via a two-electron transfer mechanism as elucidated by Equations (1)-(5):

### Discharge Process:

$$Cathode : {Zn}^{2 +} + S + 2 {e}^{-} \to ZnS \qquad ( Eq . 1 )$$

$$Anode : Zn \to {Zn}^{2 +} + 2 {e}^{-} \qquad ( Eq . 2 )$$

### Charge Process:

$$Cathode : {ZnS}^{-} \to Z {n}^{2 +} + S + 2 {e}^{-} \qquad ( Eq . 3 )$$

$$Anode : Z {n}^{2 +} + 2 {e}^{-} \to Zn \qquad ( Eq . 4 )$$

$$Total : Zn + S = Z n S \qquad ( Eq . 5 )$$

A problem with aqueous Zn/S electrochemical energy storage system is their slow kinetics and large overpotential, which makes the useful energy output of the system low.

The system and method described here addresses this issue by introducing an overpotential reducing catalyst to the S-based cathode which reduces the overpotential of the conversion rection of S to ZnS and improves the kinetics. The overpotential reducing catalyst which can be, for example, a dichalcogenide catalyst or a dichalcogenide-like catalyst, is chemically compatible with the Zn/S aqueous chemistry.

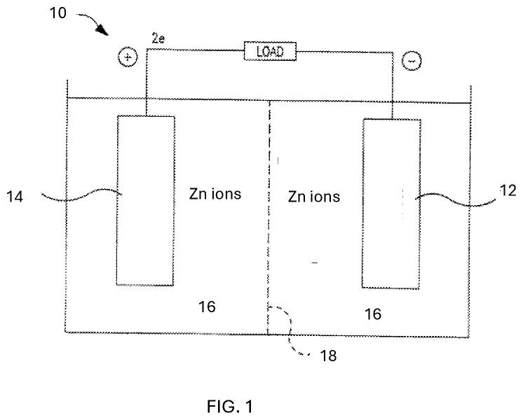

The aqueous Zn/S electrochemical energy storage system of the present disclosure will now be described in greater detail by referring to FIG. 1. Notably, an aqueous Zn/S electrochemical energy storage system 10 in accordance with an embodiment of the present disclosure is illustrated in FIG. 1. The aqueous Zn/S electrochemical energy storage system 10 includes an anode 12, a cathode 14, an aqueous electrolyte 16 and a separator 18 positioned in the aqueous electrolyte 16 and between the anode 12 and the cathode 14. Each of the anode 12, the cathode 14, the aqueous electrolyte 16 and the separator 18 are located in an electrochemical energy storage system body (not specifically shown). The anode 12 and cathode 14 can be connected to a load, as is shown in FIG. 1.

The electrochemical energy storage system body can be composed of any material such as, for example, a plastic (including, for example, polyamide, polycarbonate, polyvinyl chloride or polypropylene), a metal (including, for example, aluminum), a metal alloy (including, for example, steel), a composite (including, for example, glass fiber reinforced plastics, carbon fiber reinforced plastics and thermosets), or any combination thereof which can safely encase the anode 12, the cathode 14, the aqueous electrolyte 16 and the separator 18 of the aqueous Zn/S electrochemical energy storage system 10. In one exemplary embodiment, steel is used as the electrochemical energy storage system body since it is a sustainable material, contributing to lowering carbon footprints.

The anode 12 of the present disclosure comprises zinc. The zinc employed in providing the anode 12 is not limited. Notably, the anode 12 may include a low surface area zinc as well as a high surface area zinc. Among the low surface area zinc, it should be mentioned planar sheet, rods, etc. Among the high surface area zinc, it should be mentioned porous zinc, zinc screen, pressed zinc powder, etc. The zinc may be pure, or less pure (92% to 99%) either due to impurities or alloying. Among the impurities and alloy materials should be mentioned those common to zinc including tungsten, cobalt, lead, copper, selenium, antimony, germanium, sulfur, iron, cadmium, nickel, manganese, tin and the other known zinc alloying materials.

In some embodiments of the present disclosure, the anode 12 can include, in addition to zinc, a binder. In other embodiments, no binder is employed; this provides a binder-free anode. When used, the binder holds the anode active material, i.e., zinc, to a current collector. Illustrative binders that can be used include, but are not limited to, carboxymethyl cellulose (CMC), polyacrylic acid (PAA), polytetrafluoroethylene (PTFE), polyvinylidene fluoride (PVDF) and/or styrene butadiene rubber (SBR). The anode 12 can be formed utilizing conventional electrode forming techniques well known to those skilled in the art.

The cathode 14 of the present disclosure comprises sulfur (as the cathode active material), a catalyst for enhancing electrochemical conversion of sulfur to zinc sulfide, and at least one electrical conductivity enhancer. In the cathode 14 of the present disclosure, the sulfur, the catalyst and the at least one electrical conductivity enhancer are present in the cathode 14 in a mass ratio of from about 90:5:5 to about 1:1:1. In some embodiments, the mass ratio is from about 5:4:4 to about 2:5:5. In other embodiments, the mass ratio is from about 2:5:5 to about 5:1:4, while in yet other embodiments the mass ratio is from about 80:10:10 to about 90:5:5. In some embodiments, the cathode 14 includes molybdenum (IV) sulfide (MoS₂), as the catalyst and the at least one the at least one electrical conductivity enhancer is a carbon nanotube, and the sulfur, the molybdenum (IV) sulfide (MoS₂), and the carbon nanotube are present in the cathode in a mass ratio selected from 5:4:4, 2:5:5, 2:1:2, or 5:1:4.

The sulfur employed as the cathode 14 is not limited and can include, for example, rhombic sulfur, and/or monoclinic sulfur, in powder or particulate form. The sulfur may be pure, or less pure (92% to 99%) due to impurities or alloying. The surface area and particulate size of the sulfur are not limiting and can vary.

The catalyst (i.e., the overpotential reducing catalyst) that is employed to enhance the electrochemical conversion of sulfur to zinc sulfide comprises a dichalcogenide catalyst, a dichalcogenide-like catalyst or a combination thereof. In some embodiments, the overpotential reducing catalyst that is employed in the cathode 14 can facilitate the electrochemical formation of a zinc disulfide (ZnS₂) intermediate phase during a discharge process.

The term “dichalcogenide catalyst” is used throughout the present disclosure to denote a transition metal dichalcogenide that includes a transition metal, M, and sulfur. The transition metal, M, of the transition metal dichalcogenide is selected from Group 4 to Group 12 of the Periodic Table of Elements. Notably, M can be iron (Fe), zinc (Zn), nickel (Ni), cobalt (Co), titanium or molybdenum (Mo). In some embodiments of the present disclosure, the transition metal dichalcogenide that is employed in the cathode 14 is molybdenum (IV) sulfide (MoS₂) or a non-stoichiometric equivalent thereof. In some embodiments, the transition metal dichalcogenide is stoichiometric. By “stoichiometric”, it is meant that a compound, e.g., the transition metal dichalcogenide, has a precise and fixed ratio of its constituent elements, e.g., the transition metal and sulfur. In other embodiments, the transition metal dichalcogenide is non-stoichiometric. By “non-stoichiometric”, it is meant that a compound, e.g., the transition metal dichalcogenide, exhibits variable ratios of its constituent elements without compromising the compounds structural integrity or functionality. Besides molybdenum sulfide, iron sulfide, zinc sulfide, nickel sulfide, cobalt sulfide, or titanium sulfide (in stoichiometric or non-stoichiometric form) can be used as the dichalcogenide catalyst of the present disclosure.

The term “dichalcogenide-like catalyst” is used throughout the present disclosure to denote a transition metal compound having the formula MX, where M is as defined above and X is an oxide, nitride, or phosphide. Illustrative examples of a dichalcogenide-like catalyst that can be used in the present disclosure include, but are not limited to, nickel oxide, iron oxide, or molybdenum oxide. In some embodiments, the dichalcogenide-like catalyst is stoichiometric. In other embodiments, the dichalcogenide-like catalyst is non-stoichiometric.

Prior to incorporating the overpotential reducing catalyst into the cathode 14, the overpotential reducing catalyst can be in the form of a nanosheet catalyst, a bulk catalyst or a combination thereof. A nanosheet is a two dimensional nanostructure with a thickness typically in a range from about 1 nm to about 100 nm. The nanosheet catalysts that can be used in the present disclosure can have a surface area from about 1 m²/gm to about 300 m²/gm, with a surface area from about 5 m²/gm to about 100 m²/gm being more typical. Throughout the present disclosure and unless advised otherwise the surface area is measured by: a BET nitrogen adsorption method. The nanosheet catalysts that can be used in the present disclosure can have a pore size distribution from about 10 Angstroms to about 1000 Angstroms, with a pore size distribution from about 20 Angstroms to about 500 Angstroms being more typical. Throughout the present disclosure and unless advised otherwise the surface area is measured by: a nitrogen adsorption method. Nanosheet catalyst can be formed utilizing conventional techniques known in the art. For example, a hydrothermal synthesis process can be used for forming a nanosheet catalyst that can be used as the overpotential catalyst of the present disclosure.

A bulk catalyst is a solid material that contains a high concentration of active metal components. In some embodiments, the bulk catalyst employed may be a supported bulk catalyst in which the active metal particles are dispersed over a support material (such as, for example, alumina, silica, or a zeolite). In other embodiments, the bulk catalyst employed may be an un-supported bulk catalyst. Supported bulk catalysts have a higher surface area and, in some instances, higher catalytic activity than un-supported bulk catalysts. Supported bulk catalyst can be formed utilizing conventional techniques known in forming supported bulk catalysts. For example, impregnation or incipient wetness can be used in forming a supported bulk catalyst. The bulk catalysts that can be used in the present disclosure can have a surface area from about 0.5 m²/gm to about 10 m²/gm, with a surface area from about 2 m²/gm to about 5 m²/gm being more typical. The bulk catalysts that can be used in the present disclosure would have limited porosity typically showing a Type II isotherm consistent with a non-porous solid.

The at least one electrical conductivity enhancer that can present in the cathode 14 is a current carrier that enhances electrical conductivity of the cathode 14, contributing better charge transfer. Notably, the at least one electrically conductive enhancer comprises a carbonaceous material, an electrically conductive metal, an electrically conductive metal alloy or any combination thereof.

The carbonaceous materials that can be employed in the present disclosure as an electrical conductivity enhancer include, for example, a carbon nanotube (CNT), graphene, graphite and/or carbon black. CNTs are hollow cylindrical structures composed of carbon atoms arranged in a hexagonal lattice similar to graphene. The CNTs employed in the present disclosure can be single-wall CNTs (consisting of a single layer of graphene rolled into a tube and typically have a diameter of from about 0.5 to about 2 nm) or multi-walled CNTs (consisting of multiple layers of graphene and typically having diameters exceeding 100 nm). CNTs can be formed utilizing known techniques such as, for example, arc discharge or chemical vapor deposition.

Electrically conductive metals that can be employed in the present disclosure as an electrical conductivity enhancer include, but are not limited to, copper (Cu), cobalt (Co), tungsten (W) or aluminum (Al). Electrically conductive metal alloys that can be employed in the present disclosure as an electrical conductivity enhancer include, but are not limited to, a Cu—Al alloy.

In some embodiments of the present disclosure, the cathode 14 can include a binder. In other embodiments, no binder is employed in forming the cathode 14; the provides a binder-free cathode. Illustrative binders that can be used include, but are not limited to, carboxymethyl cellulose (CMC), polyacrylic acid (PAA), polytetrafluoroethylene (PTFE), polyvinylidene fluoride (PVDF) and/or styrene butadiene rubber (SBR).

The cathode 14 can be formed utilizing any cathode forming technique well known to those skilled in the art in which the technique is modified to include the inclusion of the overpotential reducing catalyst of the present disclosure. In one example, the cathode 14 can be prepared by mixing the various components, i.e., sulfur, overpotential reducing catalyst, at least one electrical conductivity enhancer and, optionally, the binder, to provide a precursor cathode mixture (this mixture could be a solid mixture or solids suspended in a liquid), an optional filtering step can follow the mixing, and thereafter the precursor cathode mixture is applied to a current collector providing the cathode 14 of the present disclosure. The precursor cathode mixture can be a homogeneous mixture or a non-homogenous mixture depending on the mixing conditions used. In other embodiments, a sulfur cathode could be prepared by techniques well known in the art and thereafter the overpotential catalyst could be applied to the surface of the sulfur cathode by electrodeposition or other like deposition processes.

The aqueous electrolyte 16 that is employed in the present disclosure provides zinc ions facilitating ionic transport between the anode 12 and the cathode 14. Notably, the aqueous electrolyte 16 includes a substance that conducts electricity when dissolved in water. The aqueous electrolyte 16 of the present disclosure includes zinc salt that separates into its ions (i.e., a zinc ion and its counterion), allowing electric current to flow through the solution. Some examples of zinc salts that can be employed in the aqueous electrolyte 16 of the present disclosure include, but are not limited to, zinc chloride (ZnCl₂), zinc bromide (ZnBr₂), zinc sulfate (ZnSO₄), zinc nitrate (Zn(NO₃)₂), zinc perchlorate (Zn(ClO₄)₂), zinc trifluoromethane-sulfonate (Zn(OTf)₂) and/or zinc acetate (Zn(C₂H₃O₂)). The molar concentration of the zinc salt that is present in water can vary with a typically molar concentration being from about 0.5 M to about 5.0 M.; where M is the molarity of the aqueous electrolyte 16 defined as number of moles of zinc salt per liter of water. In some preferred embodiments, the molar concentration of the zinc salt that is present in water can be from about 0.75 M to about 3.0 M, or from about 1 M to about 2.5 M. In one exemplary embodiment, the aqueous electrolyte 16 comprises zinc acetate (Zn(C₂H₃O₂)) present in a molar concentration of from about 0.75 M to about 3.0 M, with a molar concentration of about 1.0 M being more typical.

In some embodiments of the present disclosure, the aqueous electrolyte 16 can also include at least one electrolyte additive. The at least one electrolyte additive can be used to enhance the performance and stability of the aqueous Zn/S electrochemical energy storage system 10 of the present disclosure. The electrolyte additives can serve multiple functions including suppressing corrosion reactions, dendrite growth and hydrogen evolution reaction from the anode 12. Illustrative electrolyte additives that can be included in the aqueous electrolyte 16 include, for example, metal ion additives, ionic additives, surfactant additives, solid electrolyte interphase (SEI) film-forming additives and/or complexing additives. When at least one electrolyte additive is present in the aqueous electrolyte 16, the at least one electrolyte additive can be present in molar concentration of from about 0.005 M to about 1 M, with a molar concentration from about 0.02 M to about 0.2 M being more typical. In certain embodiments of the present disclosure, no electrolyte additive is employed. In one example, I₂ is used as an electrolyte additive. In other examples, sodium iodide, potassium iodide, zinc iodide and/or cesium iodide are used as the electrolyte enhancer.

In some embodiments, the aqueous electrolyte 16 can also include an organic cosolvent such as, for example, ester cosolvents (such as, for example, dimethyl carbonate (DMC), diethyl carbonate (DEC) and ethyl carbonate (EC)), alcohol cosolvents (such as, for example, ethylene glycol (EG)), and/ether cosolvents (such as, for example, tetraglyme (G4)). When an organic cosolvent is present in the aqueous electrolyte 16, the an organic cosolvent can be present in molar concentration of from about 0.05 M to about 5 M, with a molar concentration from about 0.1 M to about 2 M being more typical. In certain embodiments of the present disclosure, no co-surfactant is employed.

The separator 18 of the present disclosure prevents direct contact between the anode 12 and the cathode 14, while allowing ionic charge transfer (such as, for example, Zn ions), through the aqueous electrolyte 16. The separator 18 can be a microporous separator, a nonwoven separator, a ceramic coated separator, an ion exchange separator or a composite separator. A microporous separator is typically made from a polyolefin such as, for example, polyethylene or propylene. A non-woven separator is made of a web or randomly oriented fibers such as, for example, polyethylene terephthalate (PET) or glass. A ceramic separator are microporous separators that are coated with an additional ceramic coating such as, for example, alumina or silicon. Ion exchange membranes are membranes that selectively allowing the passage of specific ions, while block other ions. Composite separators are made from a combination of different materials which are preselected to optimize performance characteristics such as thermal stability and ionic conductivity. In some embodiments, the separator 18 is a hydrophilic battery separator including a diaphragm designed to attract and absorb water. The hydrophilic battery separator can include a single layer or a composite double layer. The hydrophilic battery separator is made of a material that wets in water including, for example, polyether sulfone (PES), mixed cellulose esters (MCE), or cellulose acetate (CA). In one exemplary embodiment of the present disclosure, the separator 18 is composed of glass fiber.

Examples have been set forth below for the purpose of further illustrating the present disclosure. The scope of the present disclosure is not limited to any of the examples set forth herein.

### Example 1: MoS₂ Nanosheet and Cathode Preparation

MoS₂ nanosheets were synthesized via a one pot hydrothermal synthesis in which 0.25 mmol of (NH₄)₂MoS₄ was dissolved in deionized H₂O, and the solution was heated at 220° C. for 18 h in an autoclave, collected by centrifugation, washed with deionized water and ethanol, and dried in vacuo. The surface area of MoS₂ nanosheets was measured by nitrogen adsorption and found to be 100 m²/g. The nitrogen adsorption/desorption obtained exhibit type IV behavior according to the IUPAC classifications, which indicate mesoporous structures. The pore size distribution shows a typical size of about 20 Angstroms. The MoS₂ nanosheets consisted of several stacking layers with crystalline structures. Additionally, energy-dispersive X-ray spectroscopy (EDX), evidenced a uniform distribution of molybdenum (Mo) and sulfur(S) throughout the three-dimensional assembled nanosheets.

Free-standing binder-free cathodes were prepared by filtering a suspension of multiwalled carbon nanotubes (CNT), sulfur(S), and molybdenum sulfide (MoS₂). The exact sulfur mass of each electrode was verified via thermogravimetric analysis (TGA). The resultant S:MoS₂:CNT ratios of the electrodes were 5:4:4, 2:5:5, and 5:1:4 by mass.

### Example 2: Electrochemistry of Aqueous Zn/S Batteries Containing S-Based Cathodes Containing CNT/MoS₂

Free-standing binder-free cathodes of Example 1 were used in aqueous Zn/S Batteries including a zinc anode, an aqueous electrolyte containing water and zinc acetate (Zn(C₂H₃O₂), in which the anode and cathode of each battery were spaced apart by a separator.

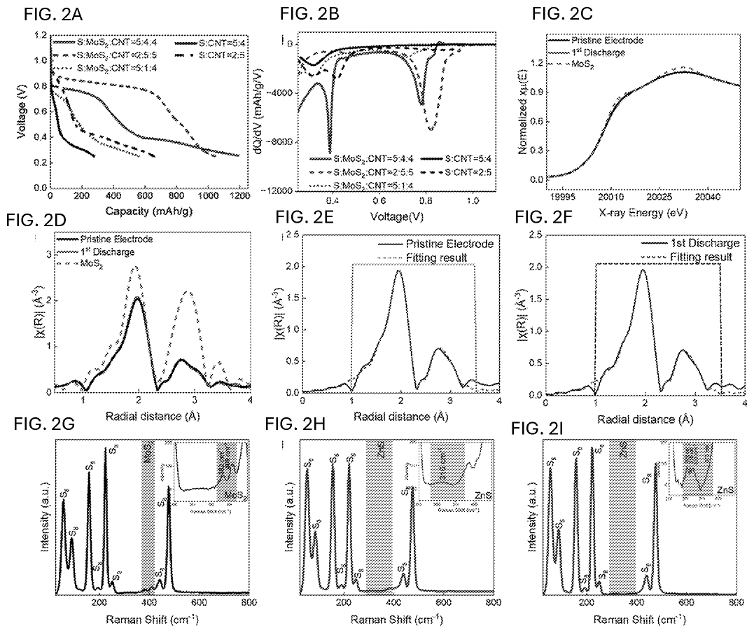

Galvanostatic discharge profiles at a current density of 100 mA/g of S to a voltage limit of 0.25 V with a 1.0 M Zn(CH₃COO)₂ electrolyte are presented in FIG. 2A. The specific capacity, calculated based on the active mass of S in the electrodes, varied significantly with different ratios of S, MoS₂, and carbon nanotubes (CNT). The 5:1:4 ratio exhibited a capacity of 558 mA h/g, with two discharge plateaus at approximately 0.78 and 0.3 V. Typically, aqueous zinc sulfur batteries show a low discharge voltage plateau around 0.4 V, attributed to sulfur reduction (S⁰ to S²⁻) with generation of zinc sulfide (ZnS) products. Therefore, the reduced polarization and observation of the higher voltage plateau are attributed to the presence of the MoS₂ catalyst. The 2:5:5 ratio demonstrated a higher capacity of 1025 mA h/g, with the discharge plateau at 0.83 V being significantly prolonged. The 5:4:4 ratio achieved a capacity of 1192 mA h/g. With the active mass S to MoS₂ catalyst ratio close to 1:1, the initial discharge plateau at 0.8 V was extended, contributing around 590 mA h/g to the capacity, while the second plateau contributed approximately 600 mA h/g. In the presence of MoS₂, the polarization was decreased, and the functional capacity was significantly improved for both compositions (by a factor of 1.6× for the 2:5 S:CNT composition and by a factor of 4× for the 5:4 S:CNT composition). A dQ/dV analysis (See, FIG. 2B) was performed to emphasize the differences in polarization, resulting in a sharp peak at 0.8 V for the more polarized higher sulfur content 2:5:5 S:MoS₂:CNT electrode relative to the lower sulfur content 5:1:4 and 5:4:4:S:MoS₂:CNT electrodes. These findings indicate that the inclusion of MoS₂ markedly improves the functional capacity of the Zn/S cells and the sulfur content also impacts the resulting polarization. Cycling data showed significantly reduced polarization and better capacity retention than the cells without MoS₂. Cycling data for Zn-based cells with S-free CNT-MoS₂ electrodes indicate that the functional capacity of the MoS₂ containing cells in the absence of sulfur is very low under these conditions (approximately 125 mA h/g).

### Example 3: Electrode Characterization

Resistivity measurements were conducted on electrodes with a 10 mm diameter using a Lucas/Signatone Four Point Probe, equipped with an SP4-50180TRY probe tip. For each electrode, four sets of measurements were taken at different orientations, and the results were averaged. The measured resistivities of the S:MoS₂:CNT and S:CNT electrodes ranged from 31 to 34 Ohm cm, with no significant differences related to the mass percentage of sulfur, MoS₂, and CNT components.

X-ray absorption near edge structure (XANES) spectra of the S:MoS₂:CNT electrodes at the Mo K-edge were collected in both the pristine state and after discharge (See, FIG. 2C). The XANES spectra of the pristine electrode closely matched those of the bulk 2H—MoS₂ reference sample, indicating a Mo oxidation state of Mo⁴⁺. Following the discharge, there were no observable changes in the XANES spectra, indicating no redox activity for Mo.

The coordination environment of the MoS₂ in the pristine state and after discharge in the composite electrode was measured via extended X-ray absorption fine structure (EXAFS) analysis. In the pristine electrode (See, FIG. 2D), the EXAFS spectrum exhibits peaks at 1.9 and 2.9 Angstroms, corresponding to the six coordinated S atoms of the nearest neighboring atom around the Mo atom, and six coordinated Mo atoms edge-sharing through S atoms within the MoO₆ triangular prism, that are characteristic paths of the 2H—MoS₂ phase. Upon discharge, no changes were detected in the EXAFS spectra, indicating that the MoS₂ coordination environment remained unchanged.

To further confirm the stability of the MoS₂ catalyst upon electrochemical discharge, extended X-ray absorption fine structure (EXAFS) spectra of the pristine and fully discharged states were analyzed using a theoretical model calculated through FEFF6 within the k-range of 3.5-14 Angstrom (See, FIGS. 2E and 2F). For both states, the EXAFS spectra were effectively fitted with the MO₂S₄ (P63/mmc) model, which includes the Mo—S and Mo—Mo paths. The bond lengths in these two states between the core metal Mo and the nearest neighboring S were found to be 2.42 (1) Angstroms, and the bond lengths between the core metal Mo and the coordinated Mo atom were 3.19 Angstroms in both states, verifying the stability of the MoS₂ catalyst.

Ex situ X-ray diffraction (XRD) and Raman measurements (FIGS. 2G-2I) were conducted to investigate the electrochemical reaction during discharge. The pristine electrode exhibited distinct diffraction peaks corresponding to S, while MoS₂ peaks were not observed due to its low crystallinity and relatively lower intensity. Upon discharging S:MoS₂:CNT to 0.25 V, the electrode displayed broad diffraction peaks at 2θ of 29°, 48°, and 57°, corresponding to the (111), (220), and (311) planes of low crystallinity cubic ZnS, suggesting a conversion reaction from S to ZnS during the discharge process. Notably, the Raman spectra discussed below support these findings.

In the Raman spectra of the pristine electrode (See, FIG. 2G), peaks at approximately 57, 89, 158, 193, 224, 252, 439, and 475 cm⁻¹ are attributed to S8,64 while peaks at 382 and 409 cm⁻¹ correspond to MoS₂. The intensity of the S peaks is notably higher, resulting in relatively reduced intensities and lower resolution of the MoS₂ peaks. An expanded inset (See, FIG. 2G) within the 370-420 cm⁻¹ range highlights the MoS₂ peaks. After discharge, the average Raman spectrum includes peaks associated with S8. However, closer inspection of the individual Raman spectra shows that only some (16 out of the 36 measured locations) contained discernible sulfur peaks. Thus, the sulfur conversion reaction progress is heterogeneous as a function of position in the electrode. FIG. 2I presents a selected area average Raman spectrum from certain regions specifically highlighting ZnS, where all spectra contained the ZnS signal. Further scrutiny of the Raman spectrum between 280 and 420 cm⁻¹ (shown in the inset of FIG. 2I) reveals peaks at 305, 316, 323, and 373 cm⁻¹, indicating the formation of ZnS and verifying the conversion of S to ZnS.

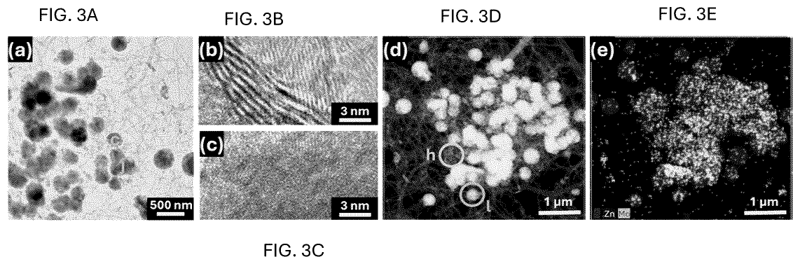

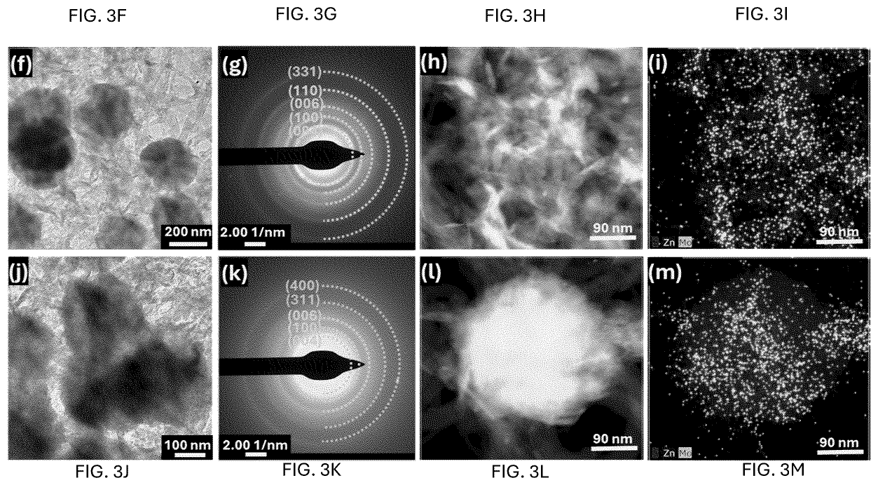

To obtain local structure, composition, and size information, TEM and HAADF images and EDX maps of aggregated solids from the discharged electrode were acquired. After discharge (See, FIG. 3A), MoS₂ and CNT are observed alongside sub-micrometer spherical particles with well-defined edges, approximately 300 nm in diameter, consistent with the results found in SEM analysis. The enlarged TEM image shown in FIG. 3B, indicated by the labeled “b” in FIG. 3A, confirms the presence of MoS₂ with retention of the nanosheet morphology following discharge. The characteristic stacking of multiple nanosheet layers that exhibit discontinuous and is matched lattice fringes can be identified as MoS₂.

In contrast, the magnified TEM image in FIG. 3C indicated by the labeled “c” in FIG. 3A, reveals the presence of new evenly distributed spherical particles after discharge, attributed to the ZnS electrochemical reduction product as described below. HAADF images and EDX analysis, shown in FIGS. 3D and 3E, verify the presence of Zn and Mo. The overlay image shows particles of ZnS due to the positional overlap of Zn and S. Furthermore, the ZnS particles are more concentrated on the MoS₂ catalyst. To validate the formation of ZnS, HRTEM images (FIGS. 3F and 3J) and the corresponding selected area electron diffraction (SAED) patterns (FIGS. 3G and 3K) were obtained. FIG. 3F shows sub-micrometer spheres with well-defined edges, close to MoS₂ and CNT. The SAED pattern in FIG. 3G displays spots corresponding to the (004), (100), (006), and (110) of MoS₂, while the spots correspond to cubic ZnS, particularly the (331) spots. The relatively weak ZnS diffraction spots are attributed to the presence of MoS₂, which may obscure the ZnS. FIG. 3J highlights the spherical particles, and the corresponding SAED pattern in FIG. 3K reveals spots for MoS₂ (004), (100), and (006) diffraction along with spots for ZnS (331) and (400) diffraction. The increased intensity of ZnS diffraction spots confirms the predominance of ZnS particles for the area probed.

To confirm the stability of MoS₂ and the formation of ZnS, enlarged HAADF and EDX maps of different regions are shown in FIGS. 3H and 3L. FIG. 3H, indicated by the circle in FIG. 3D, corresponds to areas identified as MoS₂ without ZnS spheres. The EDX maps (FIG. 3I) confirm the presence of S and Mo, verifying MoS₂ in the absence of ZnS. In contrast, the HAADF image (FIG. 3L) and the corresponding EDX map (FIG. 3M), marked by the circle in FIG. 3D, focus on spherical particles. The HAADF image displays well-defined spherical particles with a diameter of approximately 300 nm, and the EDX maps affirm the aggregation of Zn, S, and Mo on these spheres, supporting the formation of ZnS during the discharge process that is aggregated on the MoS₂ surface.

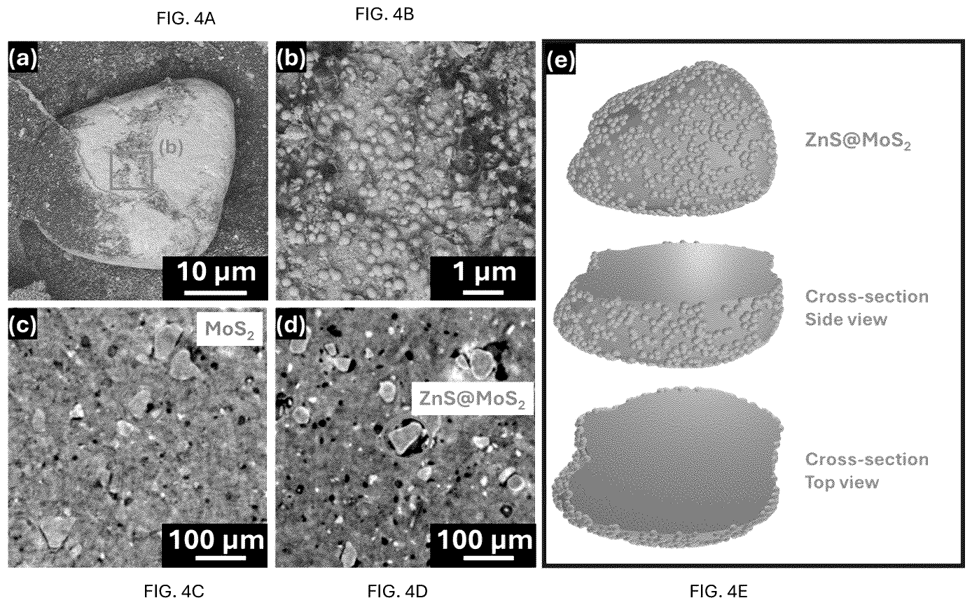

To further verify the discharge product, scanning electron microscopy (SEM) images of the intact discharged electrode are presented in FIGS. 4A-4B. Notably, SEM was able to accommodate bulk measurements of intact electrode regions where domains of larger size could be measured intact, in contrast to TEM, where suitable sample preparation demanded some disintegration of the electrode. The low-magnification SEM image in FIG. 4A reveals a representative flake approximately 30 μm in diameter, identified as MoS₂, consistent with the size and shape of the pristine MoS₂ aggregates. In the selected area shown in FIG. 4B (box in FIG. 4A), multiple well-defined spheres are observed on the surface of MoS₂, with diameters of around 300 nm. EDX maps of the discharged electrode also support the formation of ZnS and the existence of MoS₂. These observations align with the features seen in the tomographic images as discussed in the following section and support the identification of ZnS as the discharge product.

In-situ synchrotron-based X-ray computed tomography (XCT) images providing contrast due to X-ray attenuation differences were acquired both at the pristine state and at the end of discharge. FIG. 4C shows a representative location of the pristine electrode, which is circled and labeled as MoS₂. These regions measure approximately 20-50 μm and are prominent throughout the electrode.

After discharge, shown in FIG. 4D, the MoS₂ flakes remain observable; however, a white coating is evident on their surfaces, as indicated by the circle. This white coating is attributed to the ZnS discharge product, as verified via electron microscopy as discussed below. Additionally, several small white points and particles, which were not present in the pristine electrode image, are distributed across the surface. These features are also attributed to ZnS formation. A conceptual schematic consistent with SEM and XCT is presented in FIG. 4E. Collectively, the electrode observations indicate that MoS₂ remains stable after discharge, in alignment with the XRD, Raman, XANES, and EXAFS analyses, yet it is closely affiliated with the formation of the ZnS discharge product.

### Example 4: In Situ (μ-XRF) Mapping

To compare the sulfur redox behavior at the bulk electrode and the electrode-electrolyte behavior at the bulk electrode and the electrode-electrolyte interfaces, S K-edge μ-XRF maps and μ-XANES data were collected in situ within an intact cell before and after the electrochemical discharge-charge process at 4 regions (R1: bulk cathode, R2: cathode-electrolyte interface, R3: electrolyte, R4: anode-electrolyte interface). The associated voltage curves and XANES spectra acquired during discharge and charge were also collected. For the data collected after the discharge and charge of the cell containing the CNT-S electrode, the μ-XANES spectra showed minimal spectral changes at R1, consistent with significant unreacted bulk sulfur in the cathode, agreeing well with the limited (dis) charge capacities delivered. Within the electrolyte (R3) and at the anode-electrolyte (R4) interface in the CNT-S cells, sulfur species dissolution and oxidation were indicated at the cathode-electrolyte interface (R2), in the electrolyte (R3), and at the anode-electrolyte interface (R4) by the increased intensity of the peak at 2482.4 eV attributed to soluble SO₄²⁻ species.

In the electrode containing the MoS₂ catalyst, after the discharge-charge cycle, both R1 and R2 showed peaks at 2472.8 and 2482.6 eV, suggesting that the reduced sulfur species did not fully oxidize to sulfur upon charge with formation of ZnSO₄. Within the electrolyte (R3) and at the negative electrode (R4), the SO₄²⁻ peak at 2482.6 eV was more suppressed in the MoS₂ containing electrode compared to the MoS₂-free electrode. This suggests that MoS₂ may play a role as a trapping agent, confining dissolved SO₄²⁻ species at the positive electrode. Spectral features at the zinc negative electrode interface (R4) resembled the ZnS standard. No intermediate ZnS₂ phase was observed in the in situ XAS data. This was consistent with expectations, since the in situ data were collected at the end of charge and the ZnS₂ intermediate discharge product was expected to be short-lived based on prior DFT predictions.

### Example 5: Operando μ-XAS Characterization, Simulation, and Fitting Operando S

K-edge μ-XANES data based on XRF measurements were acquired at the cathode (R1) position during electrochemical discharge-charge cycling. The corresponding voltage profiles and experimental and simulated XANES spectra were obtained. The operando S μ-XANES data showed a minimal shift in the S white line energy during (dis) charge of the CNT-S cell, which agrees well with the modest capacities of about 200 mA h g⁻¹ delivered.

In the CNT-S-MoS₂ cell, the discharge capacity tripled to about 600 mA h g⁻¹ with two distinct voltage plateaus at 0.74 and 0.4 V. Much smaller discharge overpotentials were noted in the presence of the MoS₂ catalyst, consistent with the other electrochemistry results above. During discharge, the S K-edge white line energy gradually shifted from 2472.6 to 2473.8 eV, which agrees well with previous reports for conversion from elemental S8 to ZnS. An additional peak at 2478.0 eV is attributed to the midrange multiple scattering inside ZnS. Upon charge, the white line energy reversed back from 2473.7 to 2472.8 eV, consistent with a reversible conversion from ZnS back to S. In addition, a new peak located at 2482.4 eV gradually increased in intensity when charged above 1.4 V, indicating the formation of soluble SO₄²⁻ species.

In order to assess the evidence for the proposed intermediate ZnS₂ phase, fits of the operando XAS data were completed and compared including and excluding a ZnS₂ basis set. S K-edge XAS simulations were generated using VASP, where the structures for simulation were acquired from the Materials Project, specifically using mp-77 for S, mp-10695 for ZnS, and mp-1102743 for ZnS₂. Quantitatively, the mean squared errors of the fits with ZnS₂ were smaller than those without ZnS₂ after the onset of discharge and throughout charge, supporting the idea that ZnS₂ may be an intermediate phase in the discharge process. Specifically, the inclusion of ZnS₂ led to noticeably better fits for early discharge spectra (D2 and D3) and most of the charge spectra (C2-C6), especially in the region between 2474 to 2482 eV. Thus, the first higher voltage discharge plateau with ZnS₂ formation and the second lower voltage plateau with ZnS formation. This highlights the value of operando measurement for capturing short-lived intermediate products of electrochemical (dis) charge.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A system for electrochemical energy storage comprising:
an anode comprising zinc;
a cathode comprising sulfur and a catalyst effective in enhancing electrochemical conversion of sulfur to zinc sulfide;
an aqueous electrolyte comprising zinc ions facilitating ionic transport between the anode and the cathode; and
a separator positioned between the anode and the cathode.

2. The system of claim 1, wherein the catalyst facilitates electrochemical formation of a zinc disulfide (ZnS₂) intermediate phase during a discharge process.

3. The system of claim 1, wherein the catalyst comprises a dichalcogenide catalyst, a dichalcogenide-like catalyst or a combination thereof.

4. The system of claim 1, wherein the catalyst comprises a transition metal dichalcogenide comprising a transition metal and sulfur.

5. The system of claim 4, wherein the transition metal dichalcogenide is stoichiometric.

6. The system of claim 4, wherein the transition metal dichalcogenide is non-stoichiometric.

7. The system of claim 4, wherein the transition metal comprises iron, nickel, cobalt, titanium or molybdenum.

8. The system of claim 1, wherein the catalyst comprises molybdenum (IV) sulfide (MoS₂).

9. The system of claim 1, wherein the catalyst comprises a nanosheet catalyst, a bulk catalyst or a combination thereof.

10. The system of claim 1, wherein the cathode further comprises at least one electrical conductivity enhancer.

11. The system of claim 10, wherein the at least one electrical conductivity enhancer comprises a carbonaceous material, an electrically conductive metal, an electrically conductive metal alloy or any combination thereof.

12. The system of claim 10, wherein the at least one electrical conductivity enhancer comprises at least a carbonaceous material, and the carbonaceous material comprises one of a carbon nanotube, graphene, graphite or carbon black.

13. The system of claim 10, wherein the sulfur, the catalyst and the at least one electrical conductivity enhancer are present in the cathode in a mass ratio of from about 90:5:5 to about 1:1:1.

14. The system of claim 10, wherein the catalyst is molybdenum (IV) sulfide (MoS₂), and the at least one the at least one electrical conductivity enhancer is a carbon nanotube, and the sulfur, the molybdenum (IV) sulfide (MoS₂), and the carbon nanotube are present in the cathode in a mass ratio selected from 5:4:4, 2:5:5, 2:1:2, or 5:1:4.

15. The system of claim 1, wherein the cathode is free of a binder.

16. The system of claim 1, wherein the cathode further comprises a binder.

17. The system of claim 1, wherein the anode, the cathode, the aqueous electrolyte and the separator are components of a battery.

18. A system for electrochemical energy storage comprising:
an anode comprising zinc;
a cathode comprising sulfur, a dichalcogenide catalyst effective in enhancing electrochemical conversion of sulfur to zinc sulfide, and at least one electrical conductivity enhancer;
an aqueous electrolyte comprising zinc ions facilitating ionic transport between the anode and the cathode; and
a separator positioned between the anode and the cathode.

19. The system of claim 18, wherein the dichalcogenide catalyst is molybdenum (IV) sulfide (MoS₂).

20. The system of claim 18, wherein the at least one electrical conductivity enhancer is a carbon nanotube.
